(19) United States
(12) Patent Application Publication
(10) Pub. No.: US 2021/0252909 A1
(43) Pub. Date: Aug. 19, 2021

(54) Pivot Irrigation System Wheel Adapters, And Related Methods

(71) Applicant: William Clay HUNTER, Bell City, MO (US)

(72) Inventor: William Clay HUNTER, Bell City, MO (US)

(21) Appl. No.: 17/177,062

(22) Filed: Feb. 16, 2021

Related U.S. Application Data
(60) Provisional application No. 62/977,612, filed on Feb. 17, 2020.

(51) Int. Cl. B60B 11/02; A01G 25/09

(52) U.S. Cl. CPC B60B 11/02; A01G 25/09

(57) ABSTRACT

The present disclosure generally relates to wheel adapters for center pivot irrigation systems. In one example embodiment, a dual-wheel adapter generally includes a spacer. The spacer includes a body having first end portion and a second end portion. A first flange is disposed at the first end portion of the body and oriented axial to the body. The first flange configured to align with a first wheel of a pivot tower and to secure the spacer to the pivot tower. A second flange is oriented axial to the body and disposed at the second portion end of the body. The second flange is configured to align with a second wheel and to secure the second wheel to the pivot tower.

### CROSS REFERENCE TO RELATED APPLICATION

This application claims priority to, and the benefit of, U.S. Provisional Patent Application Ser. No. 62/977,612, entitled Pivot Irrigation System Wheel Adapters, and Related Methods, and filed on Feb. 17, 2020, the contents of which are incorporated herein by reference in their entirety.

### FIELD

The present disclosure generally relates to pivot irrigation system wheel adapters and methods relating thereto.

### BACKGROUND

This section provides background information related to the present disclosure which is not necessarily prior art.

Irrigation systems are often used to water fields for agricultural purposes. Example irrigation systems include center pivot irrigation systems and linear irrigation systems. With respect to center pivot irrigation systems, an overhead irrigation pipeline connects to an upper portion of a central tower, from which water is supplied to the irrigation pipeline. The irrigation pipeline extends above ground from the central tower and includes a plurality of sprinklers. The irrigation pipeline is supported by, and coupled to, a plurality of pivot towers disposed along the irrigation pipeline.

Pivot towers in center pivot irrigation systems often include a drive motor, two gear boxes, and only two wheels, where each gear box is indirectly coupled to a single wheel (broadly, a single wheel configuration). The drive motor of each pivot tower, then, is configured to drive each of the two gear boxes, which are each, in turn, configured to rotate a single wheel in order to move the pivot tower, whereby the irrigation pipeline coupled thereto is rotated about the central tower in circular fashion, enabling the sprinklers to water a circular area of the field. In connection therewith, the gear ratios of the drive motors included with the pivot towers generally decrease as the distance of the pivot towers from the central tower increases, enabling the wheels of the pivot towers closer to the central tower to move the pivot towers at speeds slower than the speeds of the pivot towers father from the central tower, in order to promote a circular rotation of the irrigation pipeline (although some gear ratios of the drive motors of the pivot towers may interchange or be the same (e.g., for a sequential/contiguous pair of pivot towers, etc.)). The center pivot irrigation system may also engage the gears of the drive motors of pivot towers closer to the central tower less often, also to promote circular rotation of the irrigation pipeline.

Towable variations of center pivot irrigation systems also exist. In towable center pivot irrigations systems, the central tower may be mobile and include a plurality of wheels, such that it can be towed in connection with the irrigation pipeline, for example, by a vehicle (e.g., a tractor, etc.). In connection therewith, each single wheel included with, or coupled to, each pivot tower may often be laterally turned in a generally 90 degree fashion in a configuration that is free from the resistance and control of the gear boxes, such that the single wheel freely turns, as the irrigation pipeline is towed.

Linear (or lateral) pivot irrigation systems are similar to center pivot irrigation systems. However, instead of coupling to and rotating about a central tower, the irrigation pipeline is coupled to a linear drive cart. Similar to the central tower of a center pivot irrigation system, the linear drive cart connects at an upper portion thereof to the irrigation pipeline and supplies water into the irrigation pipeline (e.g., from an irrigation channel running the length of the field). The pivot towers often again include a drive motor, two gear boxes, and only two wheels, where each gear box is again indirectly coupled to a single wheel. However, in contrast to the typical center pivot irrigation system configurations, the gear ratios of the drive motors included with the pivot towers, as well as the drive cart, are generally the same, such that the drive motors propel each pivot tower and the drive cart of the irrigation pipeline at the same speed, thereby driving the linear pivot irrigation system in a straight line. Linear pivot irrigation systems are generally driven linearly in a back-and-forth fashion, from one end or part of an area of a field to another end or part of the field. In connection therewith, the linear pivot irrigation system may be guided, for example, by cables or a global positioning system (GPS).

### SUMMARY

This section provides a general summary of the disclosure, and is not a comprehensive disclosure of its full scope or all of its features.

Example embodiments of the present disclosure generally relate to wheel adapters for pivot irrigation systems, including center pivot irrigation systems and linear pivot irrigation systems, as well as towable variations thereof. In one example embodiment, a dual-wheel adapter of the present disclosure generally includes a spacer. The spacer includes a body having a first end portion and a second end portion. A first flange is disposed at the first end portion of the body and is oriented generally axially relative to the body. The first flange is configured to align with a first wheel of a pivot tower and to secure the spacer to the pivot tower. A second flange is oriented generally axially relative to the body and disposed at the second portion end of the body. The second flange is configured to align with a second wheel and to secure the second wheel to the pivot tower.

In another example embodiment, a pivot irrigation system of the present disclosure generally includes a central tower and/or a drive cart, an irrigation pipeline including a plurality of spans, and a plurality of pivot towers. Each pivot tower includes at least a first wheel and a second wheel. The example center pivot irrigation system also includes a plurality of spacers. Each spacer includes a body having a first end portion and a second end portion. The spacer also includes a first flange disposed at the first end portion of the body and oriented generally axially relative to the body. The first flange is configured to align with the first wheel of one of the plurality of pivot towers and to secure the spacer to the one of the plurality of pivot towers. The spacer further includes a second flange oriented generally axially relative to the body and disposed at the second portion end of the body. The second flange is configured to align with the second wheel of one of the plurality of pivot towers and to secure the second wheel of the one of the plurality of pivot towers to the one of the plurality of pivot towers.

In this example embodiment, in one implementation, the pivot irrigation system may be configured as a center pivot irrigation system including the central tower, where each of the plurality of pivot towers is configured to support the irrigation pipeline and drive the irrigation pipeline about the central tower in a circular fashion. In the alternative, the pivot irrigation system may be configured as a linear (or lateral) pivot irrigation system including the drive cart, where the drive cart includes a plurality of wheels, where each of the plurality of pivot towers and the drive cart is configured to drive the irrigation pipeline in a linear fashion.

The present disclosure also relates to methods of adapting a pivot tower for a dual-wheel configuration. In one example embodiment, a method generally includes aligning a spacer with a first wheel of a pivot tower, where the spacer includes a body having a first flange disposed at a first end portion of the body and a second flange disposed at a second end portion the body. Each of the first and second flange is oriented generally axially relative to the body. Aligning the spacer with the first wheel includes aligning the first flange with the first wheel. The spacer is secured to the pivot tower by way of the first flange, the first wheel, and a gear hub of the pivot tower. A second wheel is aligned with the second flange of the spacer. The second wheel is then secured to the pivot tower by way of the second flange of the spacer, the body of the spacer, the first flange of the spacer, the first wheel, and the gear hub.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example embodiment of a pivot irrigation system including one or more aspects of the present disclosure.

FIG. 2 is a perspective view of a pivot tower of the pivot irrigation system shown in FIG. 1, adapted in accordance with an example embodiment of the dual-wheel adapter of the present disclosure.

FIGS. 3-6 are perspective views of the pivot tower shown in FIG. 2.

FIG. 7 is a perspective view of the dual-wheel adapter in accordance with which the pivot tower shown in FIG. 2 is configured.

FIG. 8 is a top view of the dual-wheel adapter shown in FIG. 7.

FIGS. 9-10 are perspective views of the dual-wheel adapter in configuration with the pivot tower shown in FIG. 2.

FIG. 11 is another perspective view of the pivot tower shown in FIG. 2.

FIG. 12 is another perspective view of the pivot tower shown in FIG. 2, adapted in accordance with two dual-wheel adapter embodiments of the present disclosure.

FIG. 13 is a perspective view of an example embodiment of a linear pivot irrigation system including one or more aspects of the present disclosure.

FIG. 14 is an exemplary method, which can be implemented using the dual-wheel adapter of the present disclosure.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

The inventor herein has recognized that the weight of the irrigation pipeline and supporting pivot towers in pivot irrigation systems (e.g., center and linear pivot irrigation systems) causes problems with rutting. In particular, the pivot towers tend to sink into the soil of the field at which the center pivot irrigation system is employed, especially under wet conditions, due to the weight of the irrigation pipeline and the pivot towers. Not only do the tires of the wheels of the pivot towers (broadly, the driving wheels) tend to sink into the soil, but also other components of the pivot towers (e.g., the driving wheels themselves, driving wheel gearboxes, drive shaft components, and drive motors, etc.). This presents numerous problems, including interference with movement of the pivot towers (e.g., when a center pivot irrigation system is rotated about the central tower, when a tow-able center pivot irrigation system is towed, or when a linear pivot irrigation system laterally traverses a field, etc.), damage to the pivot towers and components thereof, and damage to the field and crops.

Further, center and linear pivot irrigation systems often include safety mechanisms configured to shut the entire system down (including movement thereof) when one or more pivot towers is moving out of line, in order to prevent structural damage to the system. Rutting can cause one or more pivot towers to move out of line from the other pivot towers, thereby shutting the irrigation system down.

Example embodiments of the present disclosure address these issues in connection with a pivot irrigation system wheel adapter, wherein a dual-wheel adapter of the present disclosure generally includes a spacer. For example, the spacer includes a body having first end portion and a second end portion. A first flange is disposed at the first end portion of the body and oriented generally axially relative to the body. The first flange is configured to align with a first wheel of a pivot tower and to secure the spacer to the pivot tower. A second flange is oriented generally axially relative to the body and is disposed at the second portion end of the body. The second flange is configured to align with a second wheel and to secure the second wheel to the pivot tower.

In this manner, the pivot irrigation system wheel adapter may serve as a dual-wheel adapter, whereby a second (or auxiliary) wheel may be configured in connection with each first (or original) wheel of each pivot tower, thereby distributing the weight of the irrigation pipeline and pivot towers over twice the number of wheels, so as to minimize or eliminate rutting and problems attendant thereto. What's more, the center pivot wheel adapter may be further configured, as disclosed herein, in order to accommodate a towable pivot irrigation systems (e.g., towable center pivot irrigation systems).

The inventor herein has also recognized that when configuring a pivot tower of a pivot irrigation system in a dual-wheel configuration (e.g., where an additional driving wheel is added in combination with each of the two original wheels of a pivot tower), problems may arise with soil compaction between the first wheel and the second wheel, when soil is uplifted as the adapted pivot irrigation system is rotated about a central tower in a center pivot irrigation system, laterally driven in a linear pivot irrigation system, and/or towed. Embodiments of the present disclosure address these issue in connection with a pivot wheel adapter structured to provide sufficient space between the wheels, as detailed herein.

The inventor herein has further recognized that when configuring a pivot tower of a center pivot irrigation system in a dual-wheel configuration, undue stress may be placed on the wheel drive gear boxes as a result of the circular motion of the pivot towers, which has the potential to break or damage the pivot tower (e.g., the wheel drive gear boxes of the power tower, etc.). Embodiments of the present disclosure address this issue in connection with a particular tire configuration for the first (or original) wheel and the second (or auxiliary) wheel.

With that said, embodiments of the pivot wheel adapter may be included (and configured) as part of an original pivot irrigation system, whereby the pivot wheel adapter and/or the second (or auxiliary) wheel may be, for example, conceptually included as an original component(s) of a pivot tower(s) of a center or linear pivot irrigation system, such that subsequent reconfiguration with the pivot wheel adapter is not necessarily required. Alternatively, existing systems may be retrofitted with the pivot wheel adapter (and a second, or auxiliary) wheel).

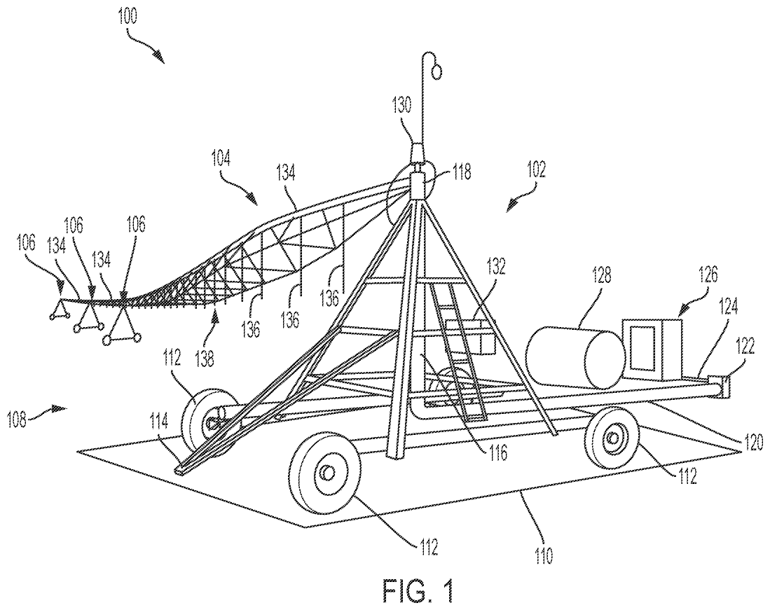

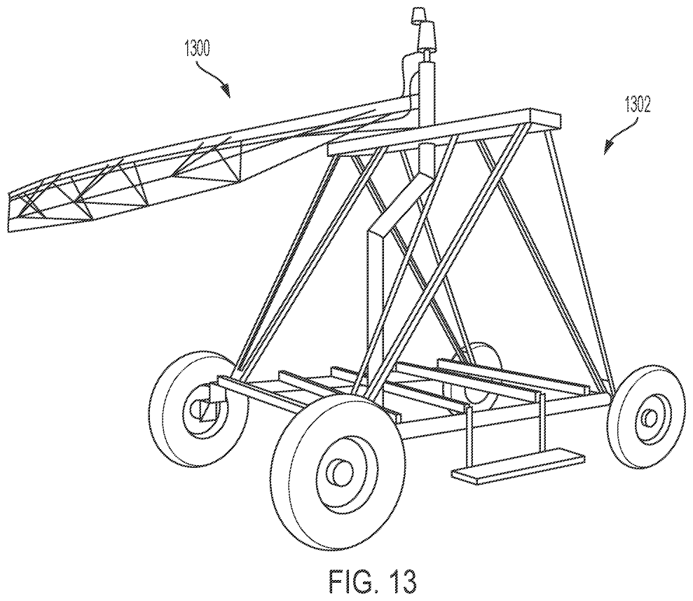

FIG. 1 illustrates an example embodiment of a pivot irrigation system 100. In this example, the pivot irrigation system 100 is a towable center pivot irrigation system. In one or more other embodiments, the pivot irrigation system may, for example be a linear pivot irrigation system (FIG. 13), or even a non-towable enter pivot irrigation system. The linear pivot irrigation system is similar to the center pivot irrigation system, with the exception of certain differences attendant to the linear pivot irrigation system's configuration to drive the entire system in a linear fashion. These differences are explained below.

With continued reference to FIG. 1, the pivot irrigation system 100 includes a central tower 102, an irrigation pipeline 104, and a plurality of pivot towers 106 (or drive towers/units 106) and is disposed at a field 108. However, in one or more other embodiments where the pivot irrigation system is a linear irrigation system, the pivot irrigation system 100 includes a linear drive cart in lieu of the central tower 102. The linear drive cart may be configured with an irrigation pipeline 104 in lieu of the central tower 102 as discussed in more detail below.

With continued reference to the example center pivot irrigation system 100 shown in FIG. 1, the central tower 102 defines (broadly, serves as) a pivot point. In connection therewith, the central tower 102 is configured to serve as point about which irrigation pipeline 104 rotates (or pivots). In the example towable center pivot irrigation system 100, the central tower 100 is anchored to the field 108. In particular, the central tower 102 is secured to the field 108 via a stationary base 110 (e.g., a concrete platform, etc.) by a plurality of chains (not shown), whereby the central tower 102 is stationary. However, the central tower 102 also includes a plurality of wheels 112 (e.g., four wheels) and a towing arm 114. In this manner, the center pivot irrigation system 100 may be unsecured from the field 108 and towed (e.g., by a vehicle (e.g., a tractor, etc.), etc.) via the towing arm 114 to another location at the field 108. With that said, in one or more other embodiments of the center pivot irrigation system, such as a non-towable center pivot irrigation system, the central tower 102 may not include any wheels and/or may be secured to the field 108 in a more permanent fashion (e.g., secured to the base 110 in a more permanent fashion (e.g., bolted, etc.), etc.).

With continued reference to FIG. 1, the central tower 102, includes a supply pipe 116 and a pivot mechanism 118. The supply pipe 116 is coupled at one lower end portion (at least indirectly) to a water source (e.g., a pipeline to a water pump, etc.) and configured to receive water therefrom. The supply pipe 116 is coupled at the other upper end portion of the supply pipe 116 to the pivot mechanism 118 and is configured to deliver water to the irrigation pipeline 104 via the pivot mechanism 118. In the example center pivot irrigation system 100, the supply pipe 116 of the central tower 102 is coupled at the lower end portion thereof to a water pipeline 120. The water pipeline 120, then, is coupled to a water pump 122 including a turbine. The water pump 122 is configured to pump water from a well and pressurize the water for delivery into the irrigation pipeline 104 (via the water pipeline 120 and the supply pipe 116). The water pump 122 is also coupled to a drive shaft 124 extending from an engine 126 (e.g., a diesel engine, etc.). The engine draws fuel from fuel tank 128 (e.g., a diesel gas tank, etc.) and is configured to rotate the shaft 124 (e.g., at 1800 rotations per minute (RPM), etc.), thereby powering the water pump 122. In one or more other embodiments, the supply pipe 116 of the central tower 102 may be coupled (directly or indirectly) otherwise at the lower end portion thereof (e.g., to a water line, etc.) to receive and direct water to supply to the irrigation pipeline 104. Further, in one or more other embodiments, the water pump may be electrically powered and receive water from one or more other sources (e.g., a water line, etc.).

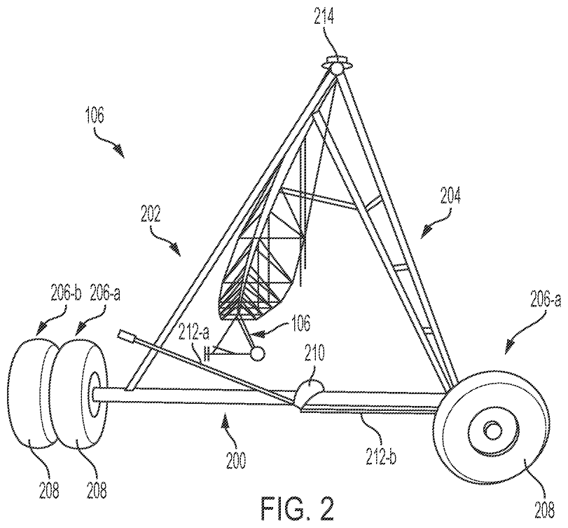

With continued reference to FIG. 1, the pivot mechanism 118 is disposed at an upper portion of the central tower 102. The pivot mechanism 118 is coupled, at a lower end portion thereof, to the upper end portion of the supply pipe 116 of the central tower 102, as noted above. The pivot mechanism 118 is coupled, at the other upper end portion thereof, to the irrigation pipeline 104. In connection therewith, the lower end portion of the pivot mechanism 118 is configured to freely rotate in connection with the fixed supply pipe 116 in a lateral 360 degree fashion. In this manner, the irrigation pipeline 104 is configured to, when coupled to the pivot mechanism 118 and propelled by the pivot towers 106 (as discussed in more detail below), freely rotate above the field 108 and about the central tower 102 in a 360 fashion. In the example center pivot irrigation system 100, the pivot mechanism 118 includes a rotatable collector ring 130 disposed in connection with the pivot mechanism 118, whereby the collector ring 130 is also free to rotate laterally in a 360 fashion according to the rotation of the pivot mechanism 118. The collector ring 130 houses a wire arrangement configured to supply electricity and/or control signals to the center pivot irrigation system 100, including to a plurality of electrically powered drive motors. An example drive motor 210 is shown in FIG. 2 and discussed in more detail below. In the example center pivot irrigation system 100, the electricity is fed from the collector ring 130 via a wire arrangement that generally extends from the collector ring 130 along the irrigation pipeline 104 to the last pivot tower 106 of the irrigation pipeline 104 (i.e., the pivot tower farthest away from the central tower 102). In one or more other embodiments, the collector ring 130 may not be included as part of the central tower 102, for example, where the drive motors are hydraulically powered (as also discussed in more detail below).

With continued reference to FIG. 1, the example center pivot irrigation system 100 is configured to receive the electricity (supplied to the irrigation pipeline 104 via the collector ring 130) from an electricity generator (not shown). The electricity generator is powered by the engine 126. In particular, in the example center pivot irrigation system 100, central tower 102 includes a control panel box 132. The central tower control panel box 132 is configured to receive the electricity from the generator (e.g., via a wire arrangement, etc.). The generator is configured to run at 1800 RPMs to generate 480 volts of three-phase power to operate the electrical system of the center pivot irrigation system. However, in one or more other embodiments, the central tower 102 (or the central tower panel box 132) may be configured to receive electricity from one or more other sources (e.g., a buried wire(s), etc.), or may not be configured to receive electricity at all (e.g., where the drive motors of the pivot towers are hydraulically powered). With continued reference to the example center pivot irrigation system 100, the central tower panel box 132 is configured, then, to provide the electricity to the irrigation pipeline 104 via the collector ring 130 (e.g., via a wire arrangement, etc.), in order to power the plurality of drive motors. In one or more other embodiments, the central tower panel box 132 may be configured to convert the electricity received to an appropriate voltage (e.g., 480 volts), when the power source (e.g., a generator, buried wire(s), etc.) does not supply power at the appropriate voltage for the center pivot irrigation system.

With continued reference to the example center pivot irrigation system 100 of FIG. 1, the central tower control panel 132 is also configured to provide appropriate control to the center pivot irrigation system 100. In connection therewith, the central tower control panel box 132 is configured (e.g., via a motherboard thereof, etc.) to communicate with a plurality of pivot tower control boxes 214 (FIG. 2) disposed along the irrigation pipeline 102 (which are also configured to communicate with the central tower control panel box 132). In connection therewith, each pivot tower control box is associated with a different one of the plurality of pivot towers 106, including a drive motor 210 thereof, and generally disposed at or near the top of each pivot tower (FIG. 2). In this manner, each pivot tower box is configured to provide appropriate control to its associated drive motor 210 based on the communication signals from the central tower control panel box 132.

Operation of the example center pivot irrigation system 100 may be controlled manually at the central tower control panel box 132 itself (e.g., system speed, direction, etc.). However, in one or more other embodiments, the center pivot irrigation system 100 may be controlled remotely, for example, by way of a wireless connection (e.g., a Wi-Fi or cellular connection, etc.) to the central tower control panel box 132 or pivot tower control boxes using an application running on a communication device (e.g., a portable communication device (e.g., a tablet or smartphone, etc.), etc.). With that said, in one or more other embodiments, the control panel box 132 may be located elsewhere the center pivot irrigation system (e.g., along the irrigation pipeline, etc.).

With continued reference to the example center pivot irrigation system 100, as discussed above, the central tower 102 is configured to couple to the irrigation pipeline 104, which is configured to rotate about the central tower 102. The irrigation pipeline 104 is defined by (broadly, includes) a plurality of spans 134 (broadly, irrigation pipeline sections). A first span 134 (i.e., the innermost span 134 closest to the central tower 102) is coupled to the central tower 102 (and, in particular, the pivot mechanism 118) on one end and to a first pivot tower 106 (i.e., the innermost pivot tower 106 closet to the central tower 102) on the other end. The first pivot tower 106 is configured to couple the first span 134 to the next span 134. Each subsequent pivot tower 106, then, is configured to couple the preceding span 134 to the next span 134, except that the last pivot tower 106 (i.e., the outermost pivot tower 106) does not necessarily couple the preceding span to a subsequent span (and may instead couple the preceding span 134 to an end-pipe with an end-gun sprinkler (now shown), or to nothing at all). In the example center pivot irrigation system 100, the last pivot tower 106 is configured to couple the preceding span 134 to an end pipe, where the end pipe includes an end-gun sprinkler at a free end thereof (now shown). In this manner, the water supplied by the central tower 102 to the irrigation pipeline 104 traverses the spans 134 to the end of the irrigation pipeline 104.

As generally explained above, the pivot towers 106 are generally configured to couple the spans 134 together, thereby defining the irrigation pipeline 104. In connection therewith, the spans 134 are coupled together with a degree of flexibility, such that one pivot tower 106 is permitted to move ahead of one or more of the other pivot towers. The pivot towers 106 are also each configured to support the irrigation pipeline 104 defined by the spans 134 (including the weight thereof) and, as discussed in more detail below, to drive (or rotate) the irrigation pipelining 104, in order to rotate the irrigation pipeline 104 in a 360 fashion about the central tower 102, thereby enabling the sprinklers 136, in this embodiment, to water a circular area of the field, as is discussed in more detail below.

The spans 134 of the irrigation pipeline 104 are also each supported by a truss system 138. As should be appreciated by one of ordinary skill in the art, the truss system 138 includes a plurality of cables and trusses. The cables extend between the pivot towers 106 (or between a pivot tower 106 and the central tower 102). Each truss attaches to and is supported by the cables at a bottom portion of the truss and attaches to, and in turn supports, a span 134 of the irrigation pipeline 104 at a top portion of the truss, whereby the truss system 138, in combination with the pivot towers 106 (and central tower 102), provides additional support to the irrigation pipeline 104 (and the spans 134 thereof).

The spans 134 of the irrigation pipeline 104 include a plurality of sprinklers 136. In the example center pivot irrigation system 100, each span 134 of the irrigation pipeline 104 includes a plurality of sprinklers 136, and the sprinklers 136 are gooseneck sprinklers, whereby each sprinkler 136 extends upwardly from a span 134 of the irrigation pipeline 104 before curving in a direction toward the field 108. The sprinklers 136, then, each include a nozzle. The nozzle is configured to disperse the water received from the central tower 102 via the irrigation pipeline 104, in order to water the field 108 as the pivot towers 106 drive the irrigation pipeline 104 about the central tower 102. It should be appreciated that the nozzle holes of sprinklers 136 disposed along the irrigation pipeline 104 closer to the central tower 102 generally have a smaller diameter than nozzle holes of sprinklers 136 farther from the central tower 102. Further, it is noted that in one or more other embodiments, the sprinklers 136 may be of a different number, type, and/or orientation, etc.

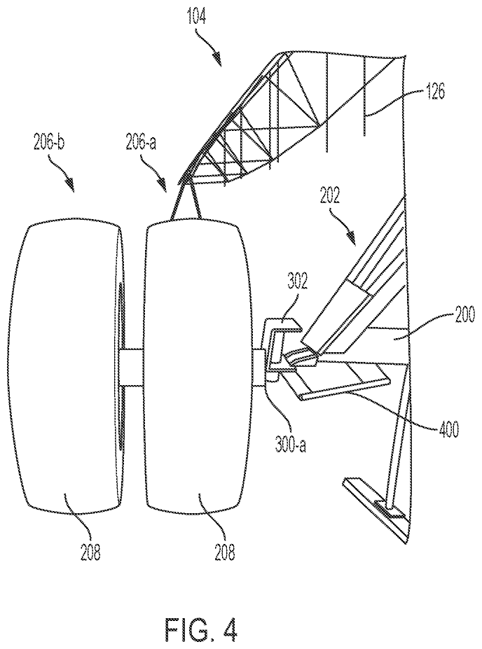

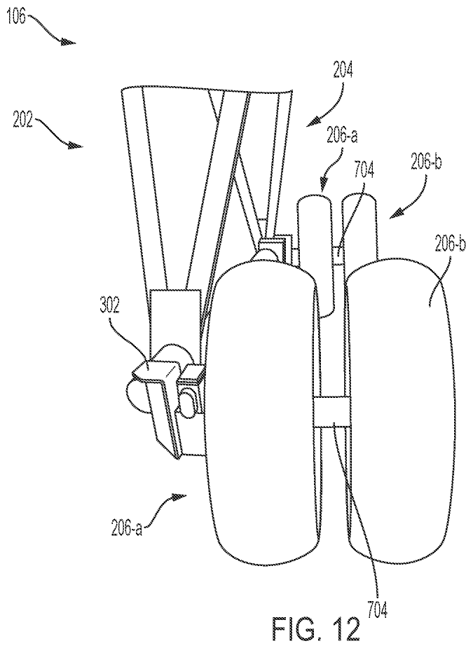

FIG. 2 shows a pivot tower 106 of the example center pivot irrigation system 100. Each pivot tower 106 is generally defined by a base 200 and two diagonal members 202 and 204, whereby the base 200 and diagonal members 202 and 204 generally form an A-frame structure. Each pivot tower 106 also includes a plurality of wheels 206-a and 206-b indirectly coupled to opposite end portions of the base 200, as discussed in more detail below. FIG. 2 illustrates a pivot tower 106 including a dual-wheel configuration with first wheel 206-a and second wheel 206-b indirectly coupled to one end portion of the base 200 by way of an embodiment of the dual-wheel adapter 700 shown in FIGS. 4 and 7-10, which is discussed in detail below. The pivot tower 106 is then shown in FIG. 2 including only a first wheel 206-a indirectly coupled to the opposite end portion of the base 200, without the benefit of an embodiment of the dual-wheel adapter 700 to accommodate a second wheel 206-b at the opposite end portion of the base 200. However, FIG. 12 shows a pivot tower 106 including a dual-wheel configuration at both end portions of the base 200 with first wheel 206-a and second wheel 206-b indirectly coupled to one end of the base 200 by way of an embodiment of the dual-wheel adapter 700 of the present disclosure and first wheel 206-a and second wheel 206-b indirectly coupled to the opposite end portion of the base 200 by way of the embodiment of the dual-wheel adapter 700 of the present disclosure. Wheels 206-a may each be referred to as an original wheel or first wheel for purposes of this disclosure, and wheels 206-b may each be referred to as an auxiliary wheel or second wheel. With that said, consistent with the above, embodiments of the present disclosure may be provided with first wheels 206-a and second wheels 206-b as part of original components of a pivot tower(s) of a center pivot irrigation system.

In the example center pivot irrigation system 100, each of the first and second wheels 206-a and 206-b of the pivot tower 106 are 24 inch (diameter) by 8.25 inch (width) wheels. Each wheel 206-a and 206-b is fitted with (broadly, includes) a 14.9 inch (width) by 24 inch (height) tire 208. The first wheels 206-a each include a tire 208 filled to a pressure higher than a pressure to which the tires 208 included with second wheels 206-b are filled. In the example pivot irrigation system 100, the inventor has found 30 PSI to be an ideal pressure for the tires 208 of the first wheels 206a and 22 PSI to be an ideal pressure for the tires 208 of the second wheels 206-b. With the tires 208 of the first wheels 206a having a pressure higher than the pressure of the tires 208 of the second wheels 206-b, the tires of 208 of the first wheels may have the ability to absorb obstructions in a field to thereby avoid undue leverage on the gear hub 306. In one or more other embodiments, the pivot towers 106 may include different wheels and/or tires (e.g., 24 inch by 8.25 inch wheels fitted with 11.2 inch by 24 inch tires, etch) and/or configurations thereof (e.g., with different sizes, pressures, etc.).

With that said, each pivot tower 106 is configured to couple the preceding span 134 to the subsequent span 104 at the vertex of the diagonal members 204 and 204 of the pivot tower 106, with the exception of the first and last pivot tower 106. Consistent with the above, the first pivot tower 106 is configured to couple the pivot mechanism 118 to the first span 134, and the last pivot tower is configured to couple the proceeding span 134 to an end pipe (not shown). With that said, in one or more other embodiments, the pivot towers 106 may take the form of one or more other structures.

With continued reference to FIG. 2, the base 200 of each pivot tower 106 includes a drive motor 210, whereby the drive motor 210 is affixed to the base 200. In the example pivot tower 106, the drive motor 210 is generally disposed along a center potion of the base 200 on the inner side of the pivot tower 106 (i.e., the side to which the wheels are coupled for rotation, which is the side facing the central tower 102). In one or more other embodiments, the drive motor 210 may be otherwise disposed. Further, in the example pivot tower 106, the drive motor 210 is configured to receive the electricity supplied from the center tower 102, in order to power the drive motor 210. In connection therewith, the drive motor 210 is configured to draw power via the wire arrangement (discussed above) extending along the irrigation pipeline 104 from the pivot mechanism 118 of the center tower 102. In one or more other embodiments, the drive motor 210 may be configured to draw electricity otherwise, for example, from a hydraulic generator (e.g., disposed along the irrigation pipeline 104 at or near the top of the pivot tower 106, etc.) configured to convert water flow through the irrigation pipeline 104 into electricity.

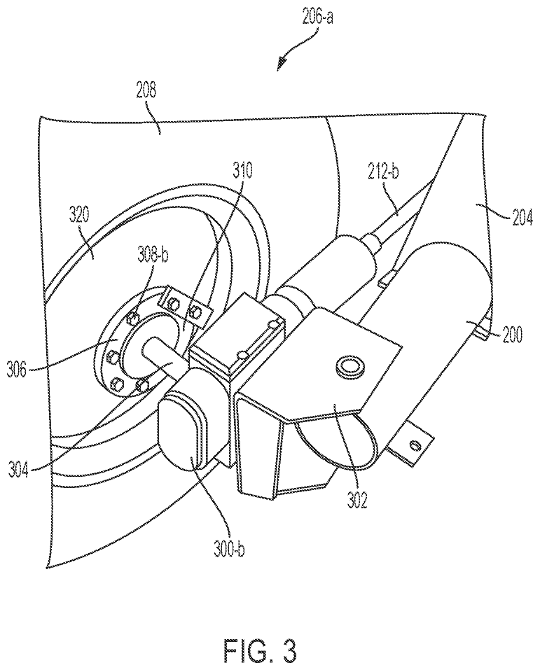

With continued reference to FIG. 2 and new reference to FIGS. 3 and 4, the base 200 of each pivot tower 106 also includes drive shafts 212-a and 212-b and two gear boxes 300-a and 300-b. The drive motor 210 is configured to turn drive shafts 212-a and 212-b. Drive shafts 212-a and 212-b are configured to couple to a gear box 300-a and 300-b, respectively. Drive shaft 212-b in a coupling arrangement with gear box 300-b disposed on one end portion of the base 200 is shown in FIG. 3. Drive shaft 212-a is configured to couple in generally the same fashion with the gear box 300-a disposed on the opposite end portion of the base 200. In the example pivot tower 106, the drive shafts 212-a and 212-b and gear boxes 300-a and 300-b are generally disposed along the outer side of the pivot tower 106 facing away from the central tower 102 (i.e., the side to which the wheels 206-a and 206-b are coupled for rotation, which is the side facing away from the central tower 102).

Further, it is noted that in the example center pivot irrigation system 100, which is a towable center pivot irrigation system, the drive shafts 212-a and 212-b are configured to removably couple to the gear boxes 300-a and 300-b, such that the drive shafts 212-a and 212-b may be physically connected to, and disconnected from, the gear boxes 300-a and 300-b in order to set the center pivot irrigation system 100 between pivot and tow modes, which are explained in more detail below. FIGS. 2 and 4 show drive shaft 212-a physically disconnected from gear box 300-a, as part of a tow mode configuration, whereas drive shaft 212-b is connected to gear box 300-b as shown in FIGS. 2 and 3, as part of a pivot (or irrigation) mode configuration. However, it should be appreciated that in a full tow mode configuration, for each pivot tower 106 of the center pivot irrigation system 100, both drive shafts 212-a and 212-b will generally be disconnected from gear boxes 300-a and 300-b, and in a full pivot mode configuration, both drive shafts 212-a and 212-b will generally be connected to gear boxes 300-a and 300-b. Further, in one or more other embodiments, the drive shafts 212-a and 212-b may be coupled in a fixed arrangement with the gear boxes 300-a and 300-b (e.g., in a non-towable center pivot irrigation system, etc.), whereby the drive shafts 212-a and 212-b do not readily disconnect from the gear boxes 300-a and 300-b.

With continued reference to FIGS. 3 and 4, the gear boxes 300-a and 300-b are disposed at opposite end portions of the base 200 of the pivot tower 106. The gear boxes 300-a and 300-b are each coupled to the base 200 via a bracket 302, where the bracket 302 is coupled to the respective end portion of the base 200. FIG. 3 shows one gear box 300-b coupled to one end portion of the base 200 via a bracket 302. FIG. 4 shows the other gear box 300-a coupled to the opposite end portion of the base 200 via another bracket 302. However, in one or more other embodiments, the gear boxes(s) may be coupled directly to the base 200 or by way of other means.

With continued reference to FIGS. 2-4, it is noted that in the example center pivot irrigation system 100, which is again a towable center pivot irrigation system, the brackets 302 are rotatably coupled to the base 200, such that each bracket 302 is configured to laterally rotate in a 90 degree fashion between pivot mode and tow mode configurations, whereby each gear box 300-a and 300-b coupled to the bracket 302 is also configured to laterally rotate in a 90 degree fashion between pivot mode and tow mode configurations, when the respective drive shaft 212-a or 212-b is disconnected from the gear box 300-a or 300-b. FIG. 3 shows a gear box 300-b and bracket 302 configured at one end of the base 200 in a pivot mode configuration, where the drive shaft 212-b is connected to the gear box 300-b at the one end. In the pivot mode configuration, the first wheel 206-a is generally aligned in parallel with the base 200. The second wheel 206-b is also generally aligned in parallel with the base 200 in the pivot mode configuration, when configured with an embodiment of the dual-wheel adapter 700 of the present disclosure, which is discussed in more detail below.

FIG. 4 shows gear box 300-a and bracket 302 configured at the opposite end of the base 200 in a tow mode configuration, where the drive shaft 212-a is disconnected from the gear box 300-a. In the tow mode configuration, the first wheel 206-a is generally aligned perpendicular to the base 200. The second wheel 206-b is also generally aligned perpendicular to the base 200 in the tow mode configuration, when configured with an embodiment of the dual-wheel adapter 700 of the present disclosure. It should be appreciated that when the pivot tower 106 is, as a whole, configured in a pivot mode configuration, the wheels 206-a and 206-b disposed at both ends of the base 200 will be generally oriented in parallel to the base 200 (as is shown in FIG. 12). Conversely, when the pivot tower 106 is, as a whole, configured in a full tow mode configuration, the wheels 206-a and 206-b disposed at both ends of the base 200 will be generally oriented perpendicular to the base 200, whereby the center pivot irrigation system 100 may be towed from an end thereof. It should be appreciated that when in a tow mode configuration, the first and second wheels 206-a and -b are locked in the perpendicular position by swinging arm linkage bars 400, so as to prevent the wheels 206-a and -b from moving or swiveling out of the towable position. When in a pivot mode configuration, the first and second wheels 206-a and -b are locked in the parallel position by the same swinging arm linkage bars 400 in a different configuration, so as to prevent the wheels 206-a and -b from moving or swiveling out of the towable position.

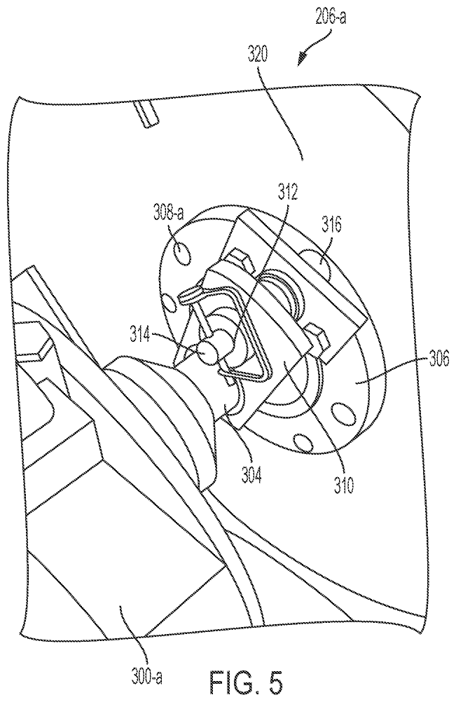

As shown in FIGS. 3 and 5, the pivot tower 106 includes a spindle 304 extending from each gear box 300-a and 300-b. The pivot tower 106 also includes a gear hub 306 (generally formed as a flange) coupled to each gear box 300-a and 300-b by way of the spindle 304. In particular, the end of the spindle 304 is received by a gear hub 306 (as part of a bearing configuration), wherein the spindle 304 is configured to rotate freely within the gear hub 306 when the spindle 304 is rotated by the gear box 300-a or 300-b, such that the gear hub 306 is coupled to the gear box 300-a or 300-b, yet capable of rotating free from control and resistance of the gear box 300-a or 300-b (e.g., in a neutral configuration).

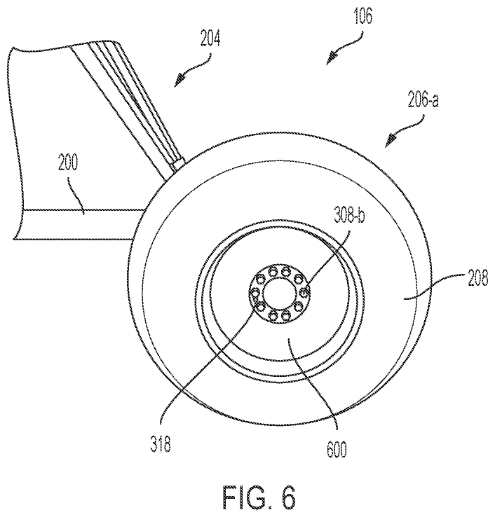

Each gear hub 306 is defined by (broadly, includes) a generally disk-shaped structure that includes a plurality of through holes and has flat inner and outer surfaces. In this manner, the outer surface of each gear hub 306 is configured to align with (e.g., abut, etc.) and couple to an inner surface 320 of the first wheel 206-a via a plurality of fasteners 308-a or 308-b (with fasteners 308-a and 308-b shown in FIGS. 3, 5, 6, and 9). In connection therewith, in the example center pivot irrigation system 100, each gear hub 306 includes a plurality of bolt holes (broadly, a bolt pattern). The bolt pattern includes eight (8) bolt holes, spaced equally apart about the gear hub 306. It should be appreciated that the bolt pattern of the gear hub 306 is configured to match a bolt pattern of the first wheel 206-a, as shown in FIG. 6, which shows the outer surface 600 of the first or original wheel 206-a (configured with a pivot tower 106 without the benefit of an embodiment of the dual-wheel adapter 700). In this manner, the gear hub 300 is configured to receive eight (8) bolts 308-a or 308-b, whereby the bolts 308-a or -b then extend through the inner surface 320 of the first wheel 206-a and protrude from the outer surface 600 of the first wheel 206-a. The bolts 308-a or 308-b, then, are each secured with a nut, thereby securing the first wheel 206-a to a pivot tower 106 by way of the gear hub 306.

It should be appreciated that bolts 308-b are used to secure the first wheel 206-a to the pivot tower 106, where the bolts 308-b are secured with a nut at the outer surface 600 of the first wheel 206-a when a gear hub 306 (e.g., the gear hub 306 coupled to gear box 300-b) is configured without the benefit of an embodiment of the dual-wheel adapter 700, as shown with the right end portion of the base 200 in FIGS. 2 and 3. However, when the gear hub 306 (e.g., the gear hub 306 couple to gear box 300-a) is configured with the benefit of the an embodiment of the dual-wheel adapter 700, as discussed in more detail below, bolts 308-a are used to secure the first wheel 206-a to the pivot tower 106, where the bolts 308-b are secured with a nut at the dual-wheel adapter 700.

Further, it should be appreciated that when a gear hub 306 (e.g., gear box 306 coupled to gear box 300-b) is configured in connection with a single wheel 206-a without the benefit of an embodiment of the dual-wheel adapter 700 in the example center pivot irrigation system 100, bolts 308-b having a 9/16-18 thread pattern are used. However, when a gear hub 306 (e.g., the gear hub 306 couple gear box 300-a) is configured in connection with an embodiment of the dual-wheel adapter 700, longer bolts 308-a are used to accommodate the dual-wheel adapter 700 (e.g., bolts 308-a having a length of about 3.0 inches and a diameter of about 0.631 inches). With that said, in one or more other embodiments, the gear hub 306 may include a different number and/or pattern of through holes (e.g., a different bolt pattern, etc.) and/or receive fasteners (e.g. bolts, etc.) of different character and/or dimension (e.g., depending on gear hub and/or wheel characteristics).

With continued reference to FIGS. 3 and 5, the spindle 304 extending from the gear boxes 300-a and 300-b includes a locking arm 310 (not shown in FIG. 3) generally oriented perpendicular to the axis of the spindle 304. The locking arm 310 is disposed between each of gear boxes 300-a and 300-b and the gear hub 306 and is configured with a through hole 312 (broadly, a pin hole) to receive a locking pin 314. As shown in FIGS. 3 and 5, the gear hub 306 includes a through hole 316 (broadly, a pin hole) aligned with a corresponding through hole 318 (broadly, a pin hole) of the first wheel 206-a coupled thereto (the pin hole 318 of the first wheel 206-a shown in FIG. 6). As can be appreciated, the pin hole 318 of the first wheel 206-a is separate from the bolt pattern of the first wheel 206-a. In this manner, each gear hub 306 is configured to turn a first wheel 206-a under the control of the drive motor 210 and gear box 300-a or 300-b, when the locking pin 314 is inserted into pin hole 312 of the locking arm 310 and through the pin hole 316 of the gear hub 306 and pin hole 318 of the first wheel 206-a, thereby locking the gear box 300-a or 300-b (and spindle 304) to the gear hub 306, such that the spindle 304 rotates the first wheel 206-a when the spindle 304 is rotated by the gear box 300-a or 300-b.

It is noted that the foregoing locking configuration may be desired when the center pivot irrigation system 100 is configured in a pivot mode, such that the drive motor 210 (via the gear boxes 300-a and 300-b, spindles 304, and gear hubs 306) may rotate the first wheels 206-a in order to rotate the irrigation pipeline 304 about the central tower 302. However, when the center pivot irrigation system 100 is configured in a tow mode, an unlocked configuration may be desired (i.e., where the locking pins 314 do not lock the spindles 304 to the gear hubs 306), such that the first wheels 206-a may turn free from the control and resistance of the gear boxes 300-a and 300-b (and, more broadly, the pivot tower 106), thereby enabling the center pivot irrigation system 100 to be towed in a neutral configuration.

It should be appreciated that, for each pivot tower 106 in the example center pivot irrigation system 100, the gear ratio of the gear boxes 300-a and 300-b generally decreases as the distance of the pivot tower 106 from the central tower 102 increases. In this manner, gear boxes 300-a and 300-b included with pivot towers 106 farther away from the central tower 102 are configured to rotate the first wheels 206-a (and second wheels 206-b when configured with an embodiments of the dual-wheel adapter 700) at speeds faster than the gear boxes 300-a and 300-b included with pivot towers 106 closer to the central tower 102, in order to promote a circular rotation of the irrigation pipeline 104 about the central tower 102. As such, the gear ratio of the gear boxes 300-a and 300-b of each pivot tower 106 decreases in a descending fashion from the central tower 102. In the example center pivot irrigation system 100, the gear boxes 300-a and 300-b of the first pivot tower 106 (i.e., the pivot tower 106 closest to the central tower 102) is configured with a 81:1 gear ratio, and the gear boxes 300-a and 300-b of the last pivot tower 106 (i.e., the pivot tower 106 farthest from the central tower 102) is configured with an 51:1 gear ratio. In one or more other embodiments, different gear ratios may be employed.

As generally noted above, embodiments of the present disclosure improve upon center pivot irrigation systems where each pivot tower is driven in a single wheel configuration (e.g., a first or original wheel 206-a at one end portion of the base 200 and another first or original wheel 206-a at the opposite end portion of the base 200 etc.). With such systems, as generally explained above, the inventor has recognized that problems with rutting may occur, whereby the weight of the irrigation pipeline and pivot towers may cause the wheels to sink into the soil of the field.

As discussed in more detail below, embodiments of the present disclosure provide for a dual-wheel center pivot adapter, such that a pivot tower may be conveniently configured in a dual-wheel configuration, whereby each gear box may be coupled (at least indirectly) to two wheels. This configuration is generally referred to herein as a dual-wheel configuration. The weight of the irrigation pipeline is then distributed over each of the two sets of wheels, thereby minimizing problems with rutting.

However, even with a dual-wheel configuration, problems with soil compaction can arise, whereby soil is uplifted and builds up between the two tires as the wheels turn, again interfering with mobility of the center pivot irrigation pipeline and damaging the field. Further, problems with stress on the wheel couplings and mobility of the irrigation pipeline can arise. What's more, where a center pivot irrigation system is a towable system, the tow mode should preferably be accounted for, such that additional components do not interfere with tow-ability. Various embodiments of the present disclosure address these issues, as discussed in more detail below.

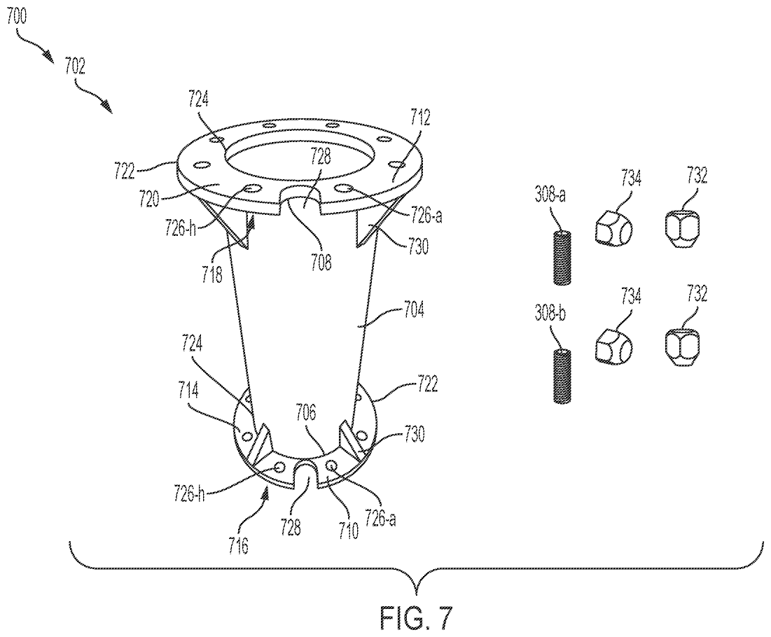

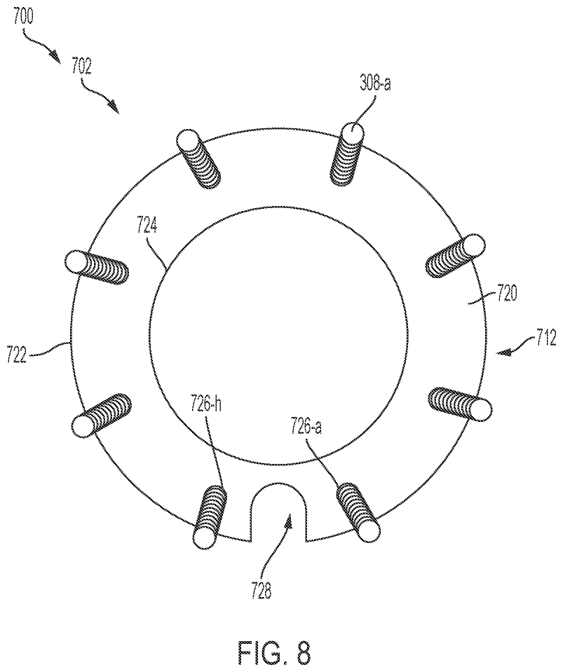

In connection therewith, FIGS. 7 and 8 show a dual-wheel center pivot irrigation system adapter 700 for the towable center pivot irrigation system 100. The dual-wheel adapter 700 is defined by (broadly, includes) a spacer 702. The spacer 702 is defined by (broadly, includes) a body 704 having a first end portion 706 and a second end portion 708. In the example dual-wheel adapter 700, the body 704 is defined by a ridged, cylindrical tube having continuous outer surface and a continuous inner surface and an opening at each end thereof. In one or more embodiments, the spacer may be defined by one or more other structures (e.g., a solid cylinder or even another shape, etc.).

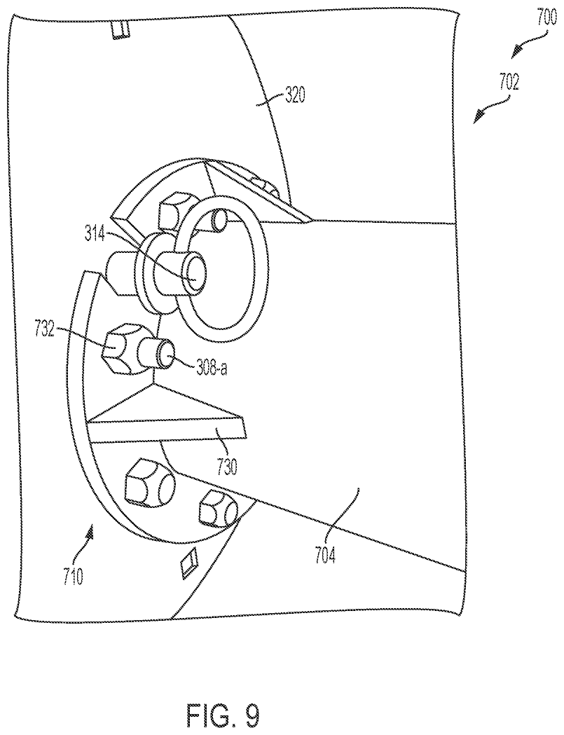

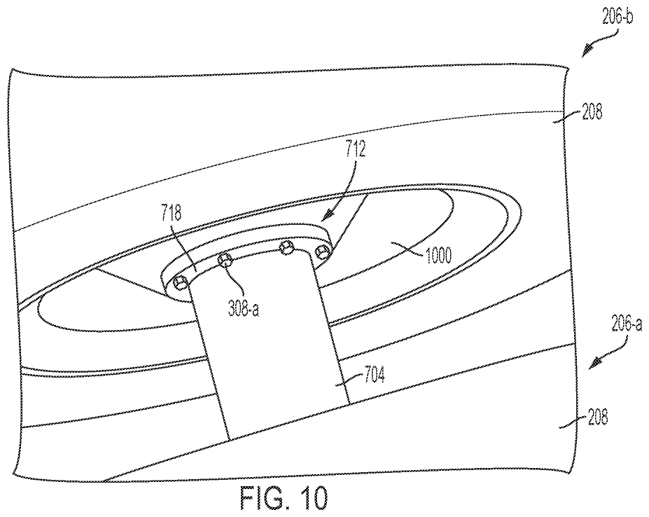

Further, in the example dual-wheel adapter 700, the spacer 702 is defined by (broadly, includes) a first flange 710 disposed at the first end portion 706 of the body 704 and oriented axial to the body 704. The spacer 702 is also defined by (broadly includes) a second flange 712 disposed at the second end portion 708 of the body 704 and oriented axial to the body 704. The first flange 710 includes a flat inner surface 714 and a flat outer surface 716 (the flat outer surface 716 structured like the flat outer surface 720 of the second flange 712, discussed below). The outer surface 716 of the first flange 706 is configured to align with (e.g., abut, etc.) the outer surface 600 of a first wheel 206-a of a pivot tower 106 of the center pivot irrigation system 100, as shown in FIG. 9. With continued reference to FIGS. 7 and 8, the second flange 712 also includes a flat inner surface 718 (the surface 718 structured like the inner surface 714 of the first flange 706) and a flat outer surface 720. The outer surface 720 of the second flange 712 is configured to align with (e.g., abut, etc.) the inner surface 1000 of the second wheel 206-b, as shown in FIG. 10.

With continued reference to FIGS. 7 and 8, in the example dual-wheel adapter 700, each of the first and second flanges 710 and 712 is defined by a disk-shaped structure (broadly, a disk) having an outer edge portion 722 and an inner edge portion 724. The inner edge portion 724 of each of the first and second flanges 710 and 712 defines an open, circular area, where the area is commensurate with the interior area of a cross section the cylindrical tube defining the body 704 of the spacer 702. With that said, in one or more other embodiments, the first and/or second flange may be defined by a structure of a different shape and/or character.

With continued reference to FIGS. 7 and 9, the first flange 710 of the spacer 702 is configured to secure the spacer 702 to a towable center pivot irrigation system pivot tower (e.g., pivot tower 106). In connection therewith, the first flange 710 includes a plurality of through holes 726-a through -h for receiving a first set of fasteners (e.g., bolts 308-a, etc.), whereby the first flange 710 is configured to secure the spacer 702 to a pivot tower 106 by way of a first wheel 206-a and a gear hub 306. In the example dual-wheel adapter 700, the first flange includes a plurality of bolt holes 726-a through -h (broadly, a bolt pattern), each having a diameter of about 0.6340 inches. The illustrated bolt pattern includes eight (8) bolt holes 726-a through -h, spaced equally apart about the inner and outer surfaces 714 and 716 first flange 710. Each of bolt holes 726-a through -h is spaced about 8 inches from the opposite bolt hole (from center point to center point). For example, the center point of bolt hole 726-a is about 8 inches apart from the center point of bolt hole 726-e. The bolt pattern of the first flange 710 is configured to match the bolt pattern of a first wheel 206-a, and the bolt pattern of a gear hub 306 (as shown in FIGS. 3, 5, and 6).

In this manner, the bolt pattern of the first flange 710 is configured to receive eight (8) bolts 308-a extending from a gear hub 306 through the inner surface 320 of the first wheel 206-a and protruding from the outer surface 600 of the first wheel 206-a, as shown in FIG. 9. The bolts 308-a, then, are each secured with a nut 732 at the inner surface 714 of the first flange 710, whereby the first flange 710 is configured to secure the spacer 702 to the pivot tower by way of the gear hub 300 and the first wheel 206-a, as shown in FIG. 9. Each nut 732 is configured to match the thread pattern of a bolt 308-a. In one or more embodiments, a different nut may be used, such as nut 734, which is a tapered nut.

Further, it is again noted that in the example center pivot irrigation system 100, bolts 308-a are longer in length than the bolts 308-b used to secure the first wheel 206-b to the gear hub 306 coupled to gear box 300-b without the benefit of an embodiment of the dual-wheel adapter 700, in order to accommodate the thickness of the first flange 710 of the spacer 702. In the example embodiment shown in FIGS. 5 and 9, the bolts 308-a have a 9/16-18 thread pattern and are longer in length that the bolts 308-b. It is also again noted that in one or more other embodiments, the first flange may include a different number and/or pattern of through holes (e.g., a different bolt pattern, etc.) and/or receive fasteners (e.g. bolts, etc.) of different character and/or dimension (e.g., depending on gear hub and/or wheel characteristics).

With continued reference to FIGS. 7, 8, and 10, the second flange 712 of the spacer 702 is also configured to secure the spacer 702 to a towable center pivot irrigation system pivot tower (including the pivot tower 106). In connection therewith, the second flange 712 includes a plurality of through holes 726-a through -h for receiving a second set of fasteners (e.g., bolts 308-a, etc.), whereby the second flange 712 is configured to secure a second wheel 206-b to a pivot tower 106 by way of the body 704 of the spacer 702, the first flange 710, the first wheel 206-a, and the gear hub 306. In the example dual-wheel adapter 700, the second flange includes a plurality of bolt holes 726-a through -h (broadly, a bolt pattern). The bolt pattern includes eight (8) bolt holes 726-a through -h, spaced equally apart about the inner and outer surfaces 718 and 720 of the second flange 712. The bolt pattern of the second flange 714 is configured to match the bolt pattern of a second wheel 206-b, which in the example center pivot irrigation system 100 is the same as the bolt pattern of the first wheel 206-a. In one or more other embodiments, the bolt pattern of the second wheel may be different than the bolt pattern of the first wheel and, accordingly, the bolt pattern of the second flange may be different from the bolt pattern of the first flange.

With continued reference to FIGS. 7, 8, 10, and 11, the bolt pattern of the second flange 712 of the spacer 702 is configured to receive eight (8) bolts 308-a extending through the inner surface 718 of second flange 712 and the inner surface 1000 of the second wheel 206-b and protruding from the outer surface 1100 of the second wheel 206-b. The bolts 308-a, then, are each secured with a nut 900 at the outer surface 1100 of the second wheel 206-b, whereby the second flange is configured to secure the second wheel 206-b to the pivot tower 106 by way of the body 704 of the spacer 102, the first flange 710, the first wheel 206-a, and the gear hub 306, as shown in FIGS. 4, 5, 9, 10, and 11. In one or more other embodiments, the second flange may include a different number and/or pattern of through holes (e.g., a different bolt pattern, etc.) and/or receive fasteners (e.g. bolts, etc.) of different character and/or dimension (e.g., depending on gear hub and/or axillary wheel characteristics).

The first flange 710 of the example dual-wheel adapter 700 is configured to accommodate the locking pin 314 and, in particular, to receive the locking pin 314 for locking the gear hub 306 (and the spindle 304) to a gear box (e.g., gear box 300-a or 300-b). In connection therewith, in the example dual-wheel adapter 700, the first flange 710 includes a pin way 728, in the form of U-shaped cut out. The pin way 728 is configured to receive the locking pin 314, when the locking pin 314 is inserted through the pin hole 312 of the locking arm 310 of the spindle 304 and the corresponding pin hole 316 of the gear hub 306 and pin hole 318 first wheel 206-a, whereby the locking pin 314 extends through and protrudes from the outer surface 600 of the first wheel 206-a. In one or more other embodiments, the first flange 710 may be structured otherwise (e.g., with a circular pin hole, etc.) to accommodate the locking pin 314. It also noted that the second flange 712 (configured to align with the inner surface 1000 of the second wheel 206-b) also includes a pin way 728, again in the form a U-shaped cut out to accommodate a locking pin. With that said, the pin way 728 of the second flange 712 is not actually used in the configuration shown in the illustrated embodiments. Rather, the pin way 728 of the second flange 712 is included with the second flange 712 for convenience, such that the second flange 712 may instead align with and be secured to the first wheel 206-a in one or more other configurations, whereby the second flange 712 may effectively serve as the first flange (and vice versa). Further, in one or more other embodiment, neither the first nor second flange may include the pin way 728, for example, when the dual-wheel adapter 700 is for a non-towable center pivot irrigation system, where the locking pin 314 may be generally unnecessary.

With continued reference to FIG. 7, the spacer 702 of the example dual-wheel adapter 700 also includes a plurality of gussets 730 disposed at each of the first and second end portions 706 and 708 of the body 704 of the spacer 702, in order to provide support for the first and second flanges 710 and 712. In connection therewith, four equally spaced gussets 730 are each disposed between the body 704 of the spacer 702 and the inner surface 714 of the first flange 710, and four equally spaced gussets 730 are disposed between the body 704 of the spacer 702 and the inner surface 718 of the second flange 712. The example gussets 730 each generally take the shape of a right triangle, with one leg affixed (and, in particular, welded) to either the inner surface 714 of the first flange 710 or the inner surface 718 of second flange 712 and the other leg affixed (and, in particular, welded) to the body 704 of the spacer 702. In one or more other embodiments, the dual-wheel adapter 700 may include a different number, affixation, or configuration of gussets, or may not include any gussets at all.

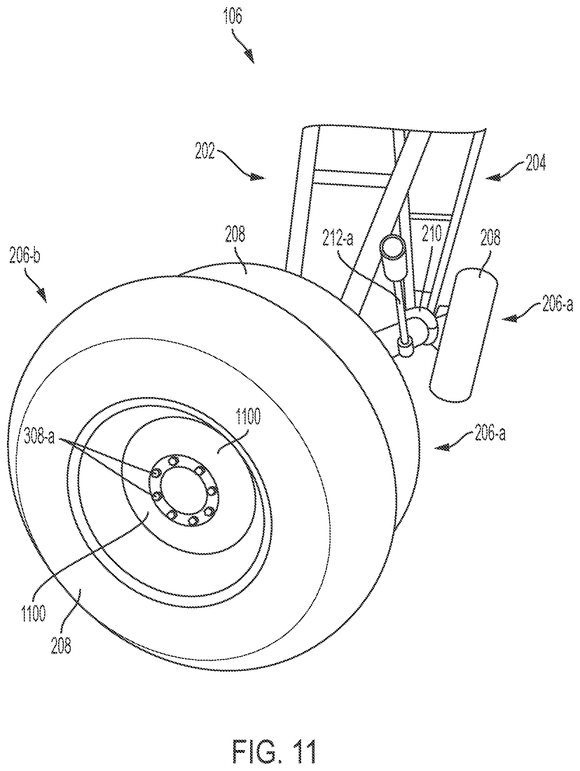

In view of the above, each pivot tower 106 of the center pivot irrigation system 100 may be conveniently configured in connection with a plurality of dual-wheel adapters 700, whereby multiple (e.g., a pair, etc.) of auxiliary wheels 206-a may be configured in connection with each pivot tower 106 originally having only a single wheel configuration, as shown, for example, in FIG. 11. What's more, the dual-wheel adapter 700 may, in one or more embodiments, even be included as part of an original center pivot irrigation system 100 and/or pivot tower.

Further, it should be appreciated that certain structures and dimensions of the example dual-wheel adapter 700 may provide particular benefits to the present disclosure.

For example, the example dual-wheel adapter 700 is comprised of steel (and includes, in particular a ridged steel and cylindrically shaped tube) and includes a plurality of gussets 730, in order to withstand the weight of the irrigation pipeline 104 and the pivot tower 106 distributed over the dual-wheel adapter 700, as well as to withstand stress imposed on the dual-wheel adapter 700 by the first and second wheels 206-a and 206-b while the wheels 206-a and 206-b rotate the pivot tower 106 about the central tower 102. With that said, in one or more other embodiments, the dual-wheel adapter 700 may be comprised one or more other materials and/or not include any gussets at all.

Further, in the example dual-wheel adapter 700, as generally explained above, each of the plurality of gussets 730 generally takes the shape of a right triangle, with a hypotenuse, adjacent side, and opposite side. However, the intersection of the hypotenuse and the adjacent side of each gusset 730 is flattened or shaved, such that each gusset 730 has a flattened or shaved side that connects the hypotenuse and opposite side of the gusset 730, as shown in in FIG. 7. The hypotenuse of each gusset 730 has a length of about 2.637 inches. The adjacent side of each gusset 730 has a length of about 2.5 inches. The opposite side of each gusset 730 has a length of about 1.375 inches. And, the flattened side of each gusset 730 has a length of about 0.25 inches. The adjacent side of each gusset 730 forms an angle of about 90 degrees relative to the opposite side. The hypotenuse of each gusset 730 forms an angle relative to the adjacent side of about 31.430 degrees. The hypotenuse of each gusset 730 forms an angle relative to the opposite side of about 58.570 degrees. And, the flattened side of each gusset 730 forms an angle relative to the hypotenuse of about 148.570 degrees and an angle relative the opposite side of about 90 degrees. Each gusset 730 has a thickness of about 0.5 inches.

The opposite side of the hypotenuse of each gusset 730 is affixed (and, in particular, welded) to the inner surface 714 of the first flange 710 or inner surface 718 of the second flange 712. The adjacent side of each gusset 730 is affixed (and, in particular, welded) to the outer surface of the body 704 of the spacer 702, such that the flattened side of each gusset is generally oriented in parallel with the body 702 of the spacer 702 and perpendicular to the inner surface 714 of the first flange 710 or the inner surface 718 of the second flange 712. With that said, as noted above, eight (8) equally spaced bolt holes 726-a-h are disposed along the disk-shaped structured defined by each of the first and second flanges 710 and 712. A first gusset 730 of each flange, then, is centrally disposed between bolt holes 726-a and -b. A second gusset 730 of each flange is centrally disposed between bolt holes 726-c and -d. A third gusset 730 of each flange is centrally disposed between bolt holes 726-e and -f. And, a fourth gusset 730 of each flange is centrally disposed between bolt holes 726-g and -h. In one or more embodiments, the gussets 730 may again be of a different, number, affixation, or configuration (or no gussets may be included at all).

As another example, the first and second flanges 710 and 712 of the example dual-wheel adapter 700 are structured in order to accommodate wheels 206-a and 206-and, in particular, 24 inch (diameter) by 8.25 inch (width) wheels and 14.9 inch (width) by 24 inch (height) tires, as well as the locking pin configuration for a pivot tower 106 of the example towable center pivot irrigation system 100. In the example dual-wheel adapter 700, each of the first and second flanges 710 and 712 includes generally the same dimensions and character. In particular, the disk-shaped structure defining each of the first and second flanges 710 and 712 has an outer diameter of about 9.4375 inches and a thickness of about 0.5 inches. That is, the diameter of the outer edge portion 722 of the disk-shaped structure is about 9.4375 inches (from one outer edge point to the opposite outer edge point). And, the diameter of the inner edge portion 722 of the disk-shaped structure is about 6.0 inches (from one inner edge point to the opposite inner edge point). The disk, then, has a width of about 3.4375 inches.

As generally explained above, eight (8) bolt holes 726-a through -h are spaced equally apart along the disk defining each of the first and second flanges 710 and 712. The bolt holes 726-a through -h are circular in form and each have a diameter of about 0.6340 inches, which generally matches the flange diameter of the gear hub 306. A distance of about 3.0 inches exists between the center point of each pair of adjacent bolt holes 726-a through -h. The distance between the center point of each bolt hole 726-a through -h and the outer edge portion 724 of the first flange 710 or second flange 712 is about 0.75 inches. The distance between center point of each bolt hole 726-a through -h and the inner edge portion 724 of the first flange 710 or second flange 712 is about 0.9375 or 15/16 of an inch. And, about 7.9375 inches exist between the center points of opposing bolt holes 762-a through -h of the first and second flanges 712 (e.g., 7.9375 inches between the center point of bolt hole 728-a and bolt hole 728-e, etc.) In connection therewith, it should be appreciated that the bolt hole configuration (broadly, the bolt pattern) substantially matches the bolt pattern of the first wheel 206-a, the second wheel 206-b, and the gear hub 306.

With that said, in one or more other embodiments, the flanges of the dual-wheel adapter may be structured otherwise, in order to accommodate one or more other types of wheels and/or tires (or sizings thereof) or gear hubs (e.g., with varying diameters form a variety of manufactures). For example, in one or more other embodiments, a dual-wheel adapter may include first and second flanges that each include a bolt pattern with 9 bolt holes that are generally equally spaced apart about the flanges. A distance of about 3.25 inches may exist between the center point of each pair of adjacent bolt holes, and the first and second flange may each have an inner diameter of about 8.875 inches. In this embodiment, the dual-wheel adapter may accommodate a wheel holding a 10.00 inch (width) by 24 inch (height) tires.

With continued reference to the example dual-wheel adapter 700, as can be appreciated from FIGS. 7 and 8, the U-shaped cut out defining the pin way 728 is defined, in part, by two generally parallel legs, where each leg has a length of about 0.777 inches and is spaced apart from the other leg by about 1.325 inches. First end portions of the legs define the opening of the U-shaped cut out. The opposite end portions of the legs are connected by an arc of about 2.08 inches. U-shaped cut out is centrally disposed between two bolt holes 726-h and -a. In connection therewith, it should be appreciated that the U-shape cut out is dimensioned of sufficient size and disposed in order to accommodate the locking pin 314 configuration of the pivot tower 106, whereby the locking pin 314 may freely protrude from the outer surface 600 of the first wheel 206-a despite an alignment of the first flange 710 of the spacer 702 therewith.

Further, the example dual-wheel adapter 700, the spacer 702 has a length of approximately 18 inches. And, the body 704 of the spacer 702, then, has a length of approximately 17 inches (from one end portion 706 of the spacer to the other end portion 708) in order to minimize problems with soil compaction when the dual-wheel adapter 700 is configured in connection with 24 inch (diameter) by 8.25 inch (width) wheels fitted with 14.9 inch (width) by 24 inch (height) by tires. In particular, the inventor has found that a spacer length of approximately 18 inches allows for a sufficient amount of space between the first and second wheels 206-a and 206-b and tires 208, such that soil uplifted between the wheels and tires by the tires does not overly compact and interfere with movement of the pivot tower, and, in turn, rotation of the irrigation pipeline.

In one or more other embodiments, the body 704 of the spacer 702 may be of a different length, for example, to provide a sufficient amount of spacing when the dual-wheel adapter is configured in connection with a different type(s) of wheel and/or tire(s). For example, in order to accommodate 24 inch by 8.25 inch wheels fitted with 11.2 inch (width) by 24 inch (height) tires, the spacer of the dual-wheel adapter may have a length of approximately 14 inches, where the body then has a length of approximately 13 inches (based on a 0.5 inch flange thickness). In this embodiment, the dual-wheel adapter may even accommodate other wheel and tire sizes (e.g., 38 inch by 8.25 inches wheels fitted with 11.2 inch by 38 inch tires, etc.) In still other embodiments, the spacer may have one or more other lengths to accommodate other sizes of tires and/or wheels. For example, in order to accommodate 24.5 by 8.25 inch wheels fitted with 16.9 inch by 24 inch tires, the spacer may have a length of approximately 20 inches, where the body of the spacer may then have a length of approximately 19 inches (based on a 0.5 inch flange thickness).

In any event, the inventor herein has found that configuring the dual-wheel adapter to maintain a minimum gap of about 4 inches between side walls of tires (when fitted on wheels coupled to the dual-wheel adapter) is beneficial, in order to minimize problems with soil compaction explained here. It should be appreciated that above referenced spacer lengths, in combination with the above-referenced wheel and tire configurations, serve to maintain such a gap. The inventor herein has also recognize that when configuration the dual-wheel adapter to have a sufficient long gap length between the side walls of tires, over extending the length of the dual-wheel adapter can introduce problems, whereby too much leverage may be placed on the outer wheel and tire (e.g., wheel 206-b fitted with tires 208, etc.), which risks harm to the gear box (e.g., gear boxes 300-a and -b) and drive line (e.g., the drive motor 210 and drive shafts 212-a and -b, etc.). It should be appreciated that the above referenced spacer lengths, in combination with the above-referenced wheel and tire configurations, serve to inhibit such harm.

As noted above, where the pivot irrigation system is a linear irrigation system, the pivot irrigation system 100 includes a linear drive cart in lieu of the central tower 102. FIG. 13 includes a perspective view of a linear liner pivot irrigation system 1300 with a linear drive cart 1302. As would be understood by one of ordinary skill in the art, the drive cart 1302 includes a plurality of wheels to help propel the linear pivot irrigation 1300 system during operation. In particular, the linear pivot irrigation system 1302 also includes a plurality of similarly configured pivot towers (not shown in FIG. 13), also connected together by spans of an irrigation pipeline, as in the example center pivot irrigation system 100. However, the drive cart 1302 is generally considered to replace the central tower of a central pivot irrigation system, whereby both the drive cart 1302 and the pivot towers are generally configured to drive the irrigation pipeline of the linear pivot irrigation system in a straight line in a back-and-forth fashion, from one end or part of an area of a field to another end or part of the field. However, as would also be understood by one of ordinary skill in the art, given the mobile nature of the drive cart 1302 during operation, the drive cart 302 is generally configured to house certain components that may be external to the central tower of a center pivot irrigation system, such as a fuel tank which may provide fuel to an engine on-board the drive cart 1302 (e.g., to power a generator to supply electrically to a motor of the drive cart 1302 and the motors of the pivot towers, etc.). The drive cart 1302, then, may be configured to obtain water from a water supply line and provide the water to the irrigation pipeline.

With that said, the pivot towers of the linear pivot irrigation system 1300 may also be beneficially adapted in accordance with the dual-wheel adapter of the present disclosure, consistent with the above explanation of the dual-wheel adapter 700 in relation to the center pivot irrigation system 100.

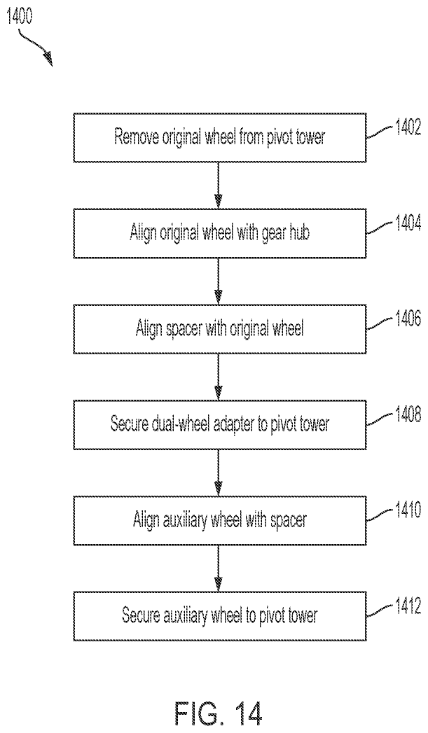

FIG. 14 illustrates a method 1400 of adapting a pivot tower 106 of a pivot irrigation system 100 in connection with the example dual-wheel adapter 700 for a dual-wheel configuration, where the pivot tower 106 is initially configured in a single wheel configuration. The method 1400 is described in relation to one pivot tower 106, one gear hub 306, one original wheel 206-a, and one auxiliary wheel 206-b. However, as can be appreciated, the method is applicable to each gear hub 306 and each original wheel 206-a of each pivot tower 106 of a pivot irrigation system 100 (e.g., a center pivot irrigation system or a linear pivot irrigation system). The method 1400 also is not limited to the example pivot irrigation system 100, pivot tower 106, wheels 206-a or 206-b, or gear hub 306.

With that said, and continued reference to FIG. 14, the method 1400 includes, at 1402, removing a first or original wheel 206-a from the pivot tower 106 of the pivot irrigation system 100. Removing the original wheel 206-a, at 1402, may include jacking up the base 200 of the pivot tower 106, loosening a plurality of fasteners securing the original wheel 206-a to the pivot tower 106 by way of the gear hub 306 (e.g., nuts securing bolts 308-b), removing the plurality of fasteners securing the original wheel 206-a to the pivot tower 106, and unmounting the original wheel 206-a from the pivot tower 106.

At 1404, the original wheel 206-a is aligned with the gear hub 306 of the pivot tower 106. In particular, in the example method 1400, the inner surface 320 of the original wheel 206-a is aligned (or re-aligned) with the gear hub 306.

At 1406, the spacer 702 of the dual-wheel adapter 700 is aligned with the original wheel 206-a. In particular, in the example method 1400, the outer surface 716 of the first flange 710 of the dual-wheel adapter 700 is aligned with the outer surface 600 of the original wheel 206-a, which is in turn aligned with the gear hub 306.

At 1408, the dual wheel adapter 700 is secured to the pivot tower 106. In the example method 1400, the spacer 702 of the dual-wheel adapter 700 is secured to the pivot tower 106 by way of the first flange 710 of the spacer 702, the original wheel 206-a, and the gear hub 306 of the pivot tower 106. Securing the dual-wheel adapter 700 to the pivot tower may include inserting a plurality of fasteners (e.g., bolts 308-a) through a bolt pattern of the gear hub 306, a bolt pattern of the original wheel 206-a, and a bolt pattern 726-a through -h of the first flange 710 of the spacer 702 of the dual-wheel adapter 700. In the example method 1400, the plurality of fasteners inserted through the gear hub 306, the original wheel 206-a, and the first flange 710 may be longer in length than the fasteners removed from the original wheel 206-a and the gear hub 306 at 1402. In one or more other embodiments, the fasteners inserted at 1408 may be of the same length as those removed at 1402, shorter in length, or even include the same fasteners removed at 1402 (e.g., bolts 308-b). With continued reference to the method 1400, the inserted fasteners are secured at the inner surface 714 of the first flange 710 of the spacer 702 (e.g., with nuts 900).

At 1410, the auxiliary wheel 206-b is aligned with the spacer 702 of the dual-wheel adapter 700. In particular, in the example method 1400, the inner surface 600 of the auxiliary wheel 206-b is aligned with the outer surface 720 of the second flange 712 of the spacer 702.

At 1412, the auxiliary wheel is secured to the pivot tower 106 by way of the second flange 702, the body 704 of the spacer 702, the first flange 710 of the spacer 102, the original wheel 206-a, and the gear hub 306. Securing the auxiliary wheel 20-b to the pivot tower 106 may include inserting a plurality of fasteners (e.g., bolts 308-a, etc.) through a bolt pattern 726-a through -h of the second flange 712 of the spacer 702 of the dual-wheel adapter 700 and a bolt pattern of the auxiliary wheel 206-b. The inserted fasteners are secured at the outer surface 1100 of the auxiliary wheel 206-b (e.g., with nuts 900).

In one or more embodiments of the method 1400, a locking pin 314 may be inserted through pin way 728 of the first flange 710 (via the pin hole 312 of the locking arm 310, the pin hole 316 of the gear hub 306 of the pivot tower 106, and the pin hole 318 of the first wheel 206-a), as part of configuring the pivot tower 106 of the center pivot irrigation system 100 for a pivot mode configuration. The locking pin 314 may also be removed from the pin way 728 of the first flange 710, as part of configuring the pivot tower 106 for a tow mode configuration.

In one or more embodiments of the method 1400, the pressure of the tire 208 of the original wheel 206-a and/or of the tire 208 of the auxiliary wheel 206-b may be adjusted (e.g., deflated, filled, etc.) such that the pressure of the tire 208 of the original wheel 206-a is greater than the pressure of the tire 208 of the auxiliary wheel 206-b, as discussed above.

In view of the above, it should be appreciated that the dual-wheel adapter of the present disclosure may be conveniently and beneficially configured in connection with a pivot tower of a pivot irrigation system (including a towable center pivot irrigation systems and linear pivot irrigation systems), in order to adapt the pivot tower for a dual-wheel configuration, thereby minimizing problems attendant to a single-wheel configuration of a pivot tower and even problems that may generally arise in a dual-wheel configuration.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments have been provided so that this disclosure will be thorough, and will fully convey the scope to those who are skilled in the art. Numerous specific details are set forth such as examples of specific components, assemblies, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, components, and/or groups thereof, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element, component, seed, member or section discussed below could be termed a second element, component, seed, member or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A dual-wheel adapter for a pivot irrigation system, the dual-wheel adapter comprising:
a spacer including:
a body having a first end portion and a second end portion;
a first flange disposed at the first end portion of the body and oriented axial to the body, the first flange configured to:
align with a first wheel of a pivot tower; and
secure the spacer to the pivot tower; and
a second flange oriented axial to the body and disposed at the second portion end of the body, the second flange configured to:
align with a second wheel; and
secure the second wheel to the pivot tower.

2. The dual-wheel adapter of claim 1, wherein the first flange includes inner and outer surfaces, the outer surface of the first flange configured to align with an outer surface of the first wheel; and
wherein the second flange includes inner and outer surfaces, the outer surface of the second flange configured to abut an inner surface of the second wheel.

3. The dual-wheel adapter of claim 2, wherein the outer surface of the first flange is configured to abut the outer surface of the first wheel; and
wherein the outer surface of the second flange is configured to abut the inner surface of the second wheel;

4. The dual-wheel adapter of claim 2, wherein each of the first and second flanges is defined by a disk-shaped structure having an outer edge portion and an inner edge portion.

5. The dual-wheel adapter of claim 1, wherein the body of the spacer is defined by a cylindrical tube.

6. The dual-wheel adapter of claim 1, wherein the first flange is configured to receive a locking pin extending through the first wheel and the gear hub, for locking the gear hub to a gear box of the pivot tower.

7. The dual-wheel adapter of claim 6, wherein the first flange includes a pin way for receiving the locking pin.

8. The dual-wheel adapter of claim 7, wherein the pin way is in the form of a U-shaped cut out.

9. The dual-wheel adapter of claim 2, wherein the spacer includes a plurality of gussets disposed between the body of the spacer and the inner surface of the first flange, each of said gussets affixed to the inner surface of the first flange and the body of the spacer; and
wherein the spacer includes a plurality of gussets disposed between the body of the spacer and the inner surface of the second flange, each of said gussets affixed to the inner surface of the second flange and the body of the spacer.

10. The dual-wheel adapter of claim 2, wherein the first flange is configured to secure the spacer to the pivot tower in connection with a plurality of through holes included therein for receiving a first set of fasteners; and
wherein the second flange is configured to secure the spacer to the pivot tower in connection with a plurality of through holes included therein for receiving a second set of fasteners.

11. The dual-wheel adapter of claim 10, wherein the first flange is configured to secure the spacer to the pivot tower by way of the first wheel and the gear hub; and
wherein the second flange is configured to secure the spacer to the pivot tower by way of the body of the spacer, the first flange, the first wheel, and the gear hub.

12. The dual-wheel adapter of claim 10, wherein a bolt pattern defines the plurality of through holes of each of the first and second flanges, the bolt pattern having eight bolt holes spaced equally apart about the respective flange, each bolt hole having a diameter of about 0.6340 inches.

13. The dual-wheel adapter of claim 1, wherein spacer has a length of either about 19 inches, about 18 inches, or about 14 inches.

14. An irrigation system comprising:
at least one of a central tower and/or a drive cart;
an irrigation pipeline including a plurality of spans;
a plurality of pivot towers, each of the plurality of pivot towers configured to support the irrigation pipeline and drive the irrigation pipeline, each pivot tower including at least a first wheel and a second wheel; and
a plurality of spacers, each spacer including:
a body having first end portion and a second end portion;
a first flange disposed at the first end portion of the body and oriented axial to the body, the first flange configured to:
align with the first wheel of one of the plurality of pivot towers; and
secure the spacer to the one of the plurality of pivot towers; and
a second flange oriented axial to the body and disposed at the second portion end of the body, the second flange configured to:
align with the second wheel of one of the plurality of pivot towers; and
secure the second wheel of the one of the plurality of pivot towers to the one of the plurality of pivot towers.

15. The irrigation system of claim 14, wherein at least one of the plurality of pivot towers includes:
a base;
at least one gear box;
a spindle extending from the at least one gear box; and
a gear hub configured to couple to the gear box by way of the spindle and to receive a plurality of fasteners, and
wherein the first flange of at least one of the plurality of spacers is configured to receive a plurality of fasteners extending from the gear hub through the first wheel;

16. The irrigation system of claim 15, including a central tower;
wherein each of the plurality of pivot towers is configured drive the irrigation pipeline about the central tower;
wherein the at least one of the plurality of pivot towers includes a rotatable bracket;
wherein the at least one gear box is configured to couple to the base of the at least one of the plurality of pivot towers by way of the rotatable bracket;
wherein the spindle includes a locking arm configured to receive a locking pin and lock the at least one gear box to the gear hub; and
wherein the first flange is configured to receive the locking pin.

17. The irrigation system of claim 14, wherein the first wheel of at least one of the plurality of pivot towers has a first pressure and the second wheel of at least one of the plurality of pivot towers includes a tire having a second pressure, the first pressure greater than the second pressure.

18. The irrigation system of claim 14, including a drive cart, the drive cart including a plurality of wheels;
wherein the plurality of pivot towers and the drive cart are configured to drive the irrigation pipeline in a linear fashion.

19. A method of adapting a pivot tower for a dual-wheel configuration, the method comprising:
aligning a spacer with a first wheel of a pivot tower, the spacer including a body having a first flange disposed at a first end portion of the body and a second flange disposed at a second end portion the body, each of the first and second flange oriented axial to the body, wherein aligning the spacer with the first wheel includes aligning the first flange with the first wheel;
securing the spacer to the pivot tower by way of the first flange, the first wheel, and a gear hub of the pivot tower;
aligning a second wheel with the second flange of the spacer; and
securing the second wheel to the pivot tower by way of the second flange of the spacer, the body of the spacer, the first flange of the spacer, the first wheel, and the gear hub.

20. The method of claim 19, further comprising adjusting a pressure of a tire of the first wheel to a pressure greater than a pressure of a tire of the second wheel.
